(19) United States
(12) Patent Application Publication
(10) Pub. No.: US 2026/0067741 A1
(43) Pub. Date: Mar. 5, 2026

(54) PDU SET DEFINITION IN A WIRELESS COMMUNICATION NETWORK

(71) Applicant: Lenovo (Singapore) Pte. Limited, Singapore (SG)

(72) Inventors: Razvan-Andrei Stoica, Essen (DE); Dimitrios Karampatsis, Ruislip (GB); Prateek Basu Mallick, Dreieich (DE); Joachim Löhr, Wiesbaden (DE)

(73) Assignee: Lenovo (Singapore) Pte. Limited, Singapore (SG)

(21) Appl. No.: 19/106,726

(22) PCT Filed: Sep. 30, 2022
(86) PCT No.: PCT/EP2022/077327

§ 371 Date: Feb. 26, 2025

(30) Foreign Application Priority Data
Aug. 26, 2022 (GR) 20220100709

(51) Int. Cl. H04W 28/02

(52) U.S. Cl. CPC H04W 28/0268

(57) ABSTRACT

There is provided a method comprising receiving a QoS rules configuration of QoS requirements of an XR application, and applying the received QoS rules configuration to a packet filter. The method further comprises processing a plurality of packet data units (PDUs) of the XR application with the packet filter. The method further still comprises determining a plurality of PDU sets, wherein each PDU set groups a sequence of one or more PDUs encapsulating a unit of information of the XR application; and transmitting the plurality of PDU sets to a radio access network, wherein a particular QoS rule configuration is applied to each PDU in a PDU set.

### FIELD

The subject matter disclosed herein relates generally to the field of implementing PDU set definition in a wireless communication network. This document defines a method and a node in a wireless communication network.

### BACKGROUND

Herein, extended Reality (NR) is used as an umbrella term for different types of realities of which Virtual Reality, Augmented Reality, and Mixed Reality are examples.

XR application traffic is subject to strict bandwidth and latency limitations in order to deliver an appropriate Quality of Service and Quality of Experience to an end user of an NR service. Such strict bandwidth and latency limitations can make delivery of NR application traffic over a wireless communication network challenging.

### SUMMARY

In the context of NR media traffic, 3GPP SA2 Work Group recently introduced the concept of a ‘PDU set’ to group a series of PDUs carrying a unit of information at the application-level. Each PDU within a PDU set can thus be treated according to an identical set of QoS requirements and associated constraints of delay budget and error rate while providing support to a RAN for differentiated QoS handling at PDU set level. This improves the granularity of legacy 5G QoS flow framework allowing the RAN to optimize the mapping between QoS flow and DRBs to meet stringent NR media requirements (e.g., high-rate transmissions with short delay budget).

Two problems stem from the latter activity. On one hand the determination of a PDU set and its composing PDUs, i.e., the identification of the PDU set boundaries, and on the other hand, the classification of a PDU set importance level necessary for its mapping to QoS requirements and association with a QFI and DRB. These problems need to be solved efficiently in real-time with low signaling/control overhead to enable performance benefits based on the PDU set concept.

There is presented herein a solution to the problem of determining PDU set boundaries based on a reference XR protocol stack and its deployment within a 5GS or alike wireless communication systems combining a Core Network (CN) and a RAN for accessing and communicating with a data network (DN) hosting XR specific applications (e.g., NR messaging, CG gaming, NR conferencing, NR streaming etc.). There is additionally provided a solution to determining PDU set importance.

Disclosed herein are procedures for PDU set definition in a wireless communication network. Said procedures may be implemented by a method and a node in a wireless communication network.

Accordingly, there is provided a method comprising receiving a QoS rules configuration of QoS requirements of an NR application, and applying the received QoS rules configuration to a packet filter. The method further comprises processing a plurality of packet data units (PDUs) of the NR application with the packet filter. The method further still comprises determining a plurality of PDU sets, wherein each PDU set groups a sequence of one or more PDUs encapsulating a unit of information of the NR application; and transmitting the plurality of PDU sets to a radio access network, wherein a particular QoS rule configuration is applied to each PDU in a PDU set.

There is further provided a node in a wireless communication network, the node comprising: an interface and a processor. The interface is arranged to receive a QoS rules configuration of QoS requirements of an XR application. The processor is arranged to: apply the received QoS rules configuration to a packet filter; process a plurality of packet data units (PDUs) of the XR application with the packet filter; and determine a plurality of PDU sets, wherein each PDU set groups a sequence of one or more PDUs encapsulating a unit of information of the NR application. The interface is further arranged to transmit the plurality of PDU sets to a radio access network wherein a particular QoS rule configuration is applied to each PDU in a PDU set.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for PDU set definition in a wireless communication network will now be described, by way of example only, with reference to the accompanying drawings, in which:

FIG. 1 depicts an embodiment of a wireless communication system for PDU set definition in a wireless communication network;

FIG. 2 depicts a user equipment apparatus;

FIG. 3 depicts further details of the network node;

FIG. 4 illustrates a method as presented herein;

FIG. 5 illustrates an overview of a core network XRM architecture handling of PDU sets;

FIG. 6 provides an overview of the RTP and RTCP stack;

FIG. 7 illustrates an overview of the WebRTC stack;

FIG. 8 illustrates packet format and header information for both an RTP packet and an SRTP packet;

FIG. 9 illustrates a PDU set Packet Filter comprising hierarchical processing;

FIG. 10 illustrates the application of the packet filtering in the XRM service across a 5GS in both DL and UL;

FIG. 11 is an illustration of applying of Level 0 processing PDU set packet filter on RTP stream carrying payload of video coded bitstream and mapping to PDU sets;

FIG. 12 illustrates the application of a Level 0 and a Level 1 filter process to a PDU stream; and

FIG. 13 is an illustration of applying up to Level 2 processing of the PDU set packet filter on RTP stream carrying payload of video coded bitstream.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

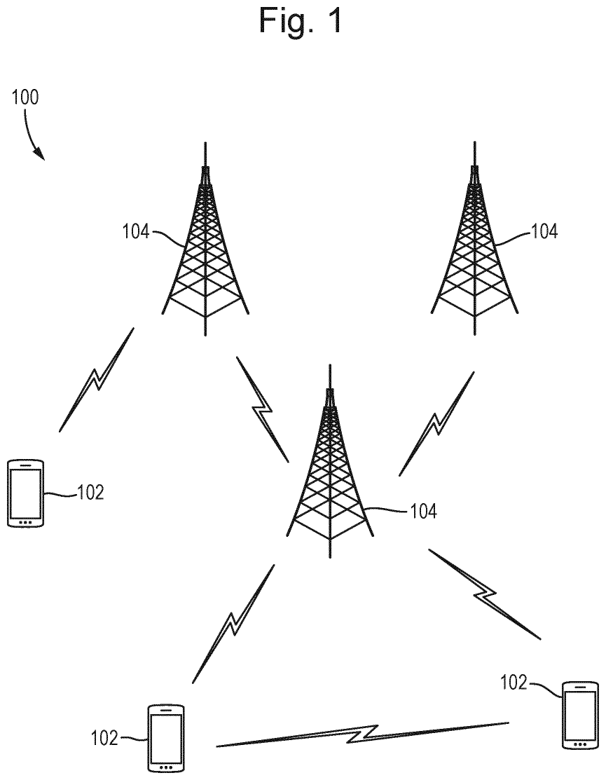

FIG. 1 depicts an embodiment of a wireless communication system 100 for PDU set definition in a wireless communication network. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100. The remote unit 102 may comprise a user equipment apparatus 200, a UE 535, or a UE 1035 as described herein. The base unit 104 may comprise a network node 300, a UPF 540, or a UPF 1040 as described herein.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WIMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

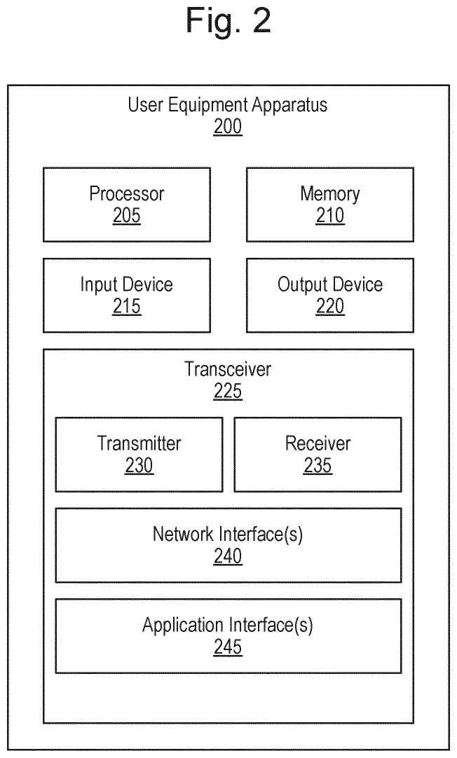

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. The user equipment apparatus 200 may comprise a remote unit 102, a UE 535, or a UE 1035 as described herein. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communications network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

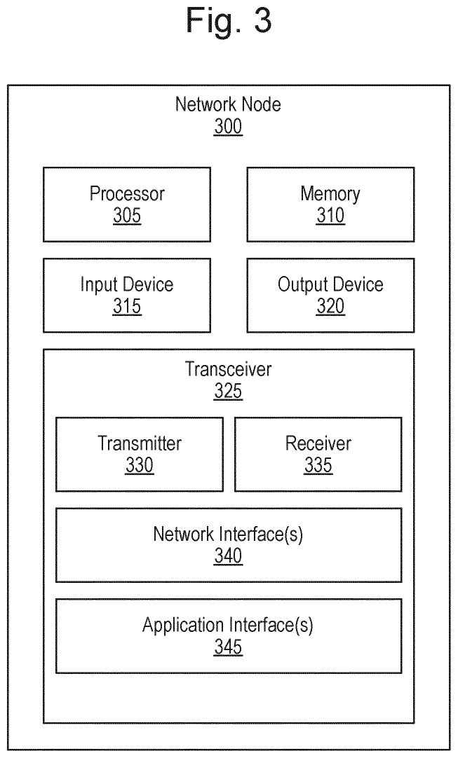

FIG. 3 depicts further details of the network node 300 that may be used for implementing the methods described herein. The network node 300 may comprise a base unit 104, a UPF 540, or a UPF 1040 as described herein. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

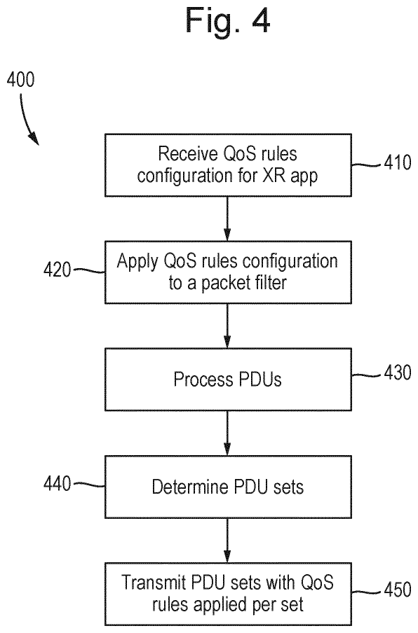

FIG. 4 illustrates a method 400 as presented herein. The method comprises receiving 410 a QoS rules configuration of QoS requirements of an NR application, and applying 420 the received QoS rules configuration to a packet filter. The method further comprises processing 430 a plurality of packet data units (PDUs) of the NR application with the packet filter. The method further still comprises determining 440 a plurality of PDU sets, wherein each PDU set groups a sequence of one or more PDUs encapsulating a unit of information of the NR application; and transmitting 450 the plurality of PDU sets to a radio access network, wherein a particular QoS rule configuration is applied to each PDU in a PDU set.

The above method tends to map XR application information units to PDU sets. The XR application traffic may thus take advantage of the benefits of delivery via PDU sets, in that a PDU set can thus be treated according to an identical set of QoS requirements and associated constraints of delay budget and error rate while providing support to a RAN for differentiated QoS handling at PDU set level. This tends to improve the granularity of legacy 5G QoS flow framework allowing the RAN to optimize the mapping between QoS flow and data radio bearers (DRBs) to meet stringent VR media requirements such as high-rate transmissions with short delay budget.

Essentially the determination of PDU set allows the RAN and associated QoS handling procedures to go beyond current best effort procedures and optimize transmission and resource allocation with a granularity of PDU set in achieving QoS requirements (e.g., meeting delay budget/error rate) of an application.

The method may further comprise classifying an importance level for at least one PDU set of the plurality of PDU sets; and using the importance level of the at least one PDU set to identify the particular QoS rules configuration to apply to each PDU in the at least one PDU set.

This tends to allow for prioritization of such PDU set level procedures according to importance classes. This may be useful for multimodal traffic flows with similar QoS treatment or traffic flows that may contain PDU sets carrying information of various importance levels for the application (e.g., I-frame vs. P-frame in video streams).

The method may further comprise using metadata provided by the application for each of the plurality of PDUs within the PDU set to determine one or more PDU sets within the PDU set and classify the importance of each of the one or more PDU sets.

A unit of information of the NR application may comprise a video frame, a video slice, or a video layer. Metadata may be provided by the application via RTP PDU extension headers.

The determined PDU sets may represent at least one of: a video coded frame, a video coded frame partition as a video coded slice, a video coded temporal layer, and a video coded spatial layer.

The packet filter processing the plurality of PDUs may comprise of a baseline processing stage, a first processing stage and a second processing stage. The baseline processing stage may comprise a zeroth processing stage. The baseline processing stage may comprise Level 0 processing. The first processing stage may comprise Level 1 processing. The second processing stage may comprise Level 2 processing.

The QoS rules configuration may define a set of importance classes used for classification of the importance level of each PDU set.

The determination of a PDU set may comprise determining a PDU set boundary, wherein a PDU set boundary is determined by means of at least one of: RTP/SRTP packet header inspection, and RTP/SRTP packet extension header inspection.

The method may further comprise using, for the determination of the PDU set boundary at least one of: RTP/SRTP packet header, M-bit marker field, sequence number field, payload type field, timestamp field, and synchronization source (SSRC) field.

The classification of the importance level for each PDU set may comprise using at least one of: the QoS rules configuration, the NR application configuration of a video codec encoding profile, the determined PDU set size, and an RTP/SRTP extension header information.

The video codec may comprise H.264, H.265, H.266, AV1, etc.

PDU set size may be measured in bytes/octets, bits or equivalent measures.

The classification of the importance level for each PDU set may further comprise utilizing information containing at least one of: importance classes determined by the QoS rules; media bandwidth requirements; video codec encoding constant bit rate configuration; video codec encoding capped variable bit rate configuration; video codec encoding expected bit rate configuration; video codec encoding constant rate factor configuration; video codec encoding maximum frame size configuration; and video codec encoding expected frames per second.

The classification of the importance level for each PDU set can be obtained by means of SDP signaling or AF signaling to the PCF.

There is further provided a node in a wireless communication network, the node comprising: an interface and a processor. The interface is arranged to receive a QoS rules configuration of QoS requirements of an XR application. The processor is arranged to: apply the received QoS rules configuration to a packet filter; process a plurality of packet data units (PDUs) of the NR application with the packet filter; and determine a plurality of PDU sets, wherein each PDU set groups a sequence of one or more PDUs encapsulating a unit of information of the XR application. The interface is further arranged to transmit the plurality of PDU sets to a radio access network wherein a particular QoS rule configuration is applied to each PDU in a PDU set.

The node may be a wireless communication device. The wireless communication device may be a user equipment (UE). The node may comprise a remote unit 102, a user equipment apparatus 200, a UE 535, or a UE 1035 as described herein. The interface may be a radio transceiver.

The node may be a network apparatus. The network apparatus may be a user plane function (UPF). The node may comprise a base unit 104, a network node 300, a UPF 540, or a UPF 1040 as described herein. The interface may be a network interface.

A unit of information of the XR application may comprise a video frame, a video slice, or a video layer. In operation, the above node tends to map NR application information units to PDU sets. The NR application traffic may thus take advantage of the benefits of delivery via PDU sets, in that a PDU set can thus be treated according to an identical set of QoS requirements and associated constraints of delay budget and error rate while providing support to a RAN for differentiated QoS handling at PDU set level. This tends to improve the granularity of legacy 5G QoS flow framework allowing the RAN to optimize the mapping between QoS flow and DRBs to meet stringent NR media requirements such as high-rate transmissions with short delay budget.

Essentially the determination of PDU set allows the RAN and associated QoS handling procedures to go beyond current best effort procedures and optimize transmission and resource allocation with a granularity of PDU set in achieving QoS requirements (e.g., meeting delay budget/error rate) of an application.

The processor may be further arranged to classify an importance level for at least one PDU set of the plurality of PDU sets and to use the importance level of the at least one PDU set to identify the particular QoS rules configuration to apply to each PDU in the at least one PDU set.

This tends to allow for prioritization of such PDU set level procedures according to importance classes. This may be useful for multimodal traffic flows with similar QoS treatment or traffic flows that may contain PDU sets carrying information of various importance levels for the application (e.g., I-frame vs. P-frame in video streams).

The processor may be further arranged to use metadata provided by the application for each of the plurality of PDUs within the PDU set to determine one or more PDU sets within the PDU set and classify the importance of each of the one or more PDU sets.

Metadata may be provided by the application via RTP PDU extension headers.

The determined PDU sets may represent at least one of: a video coded frame, a video coded frame partition as a video coded slice, a video coded temporal layer, and a video coded spatial layer.

The packet filter processing the plurality of PDUs may comprise a baseline processing stage, a first processing stage and a second processing stage.

The baseline processing stage may comprise a zeroth processing stage. The baseline processing stage may comprise Level 0 processing. The first processing stage may comprise Level 1 processing. The second processing stage may comprise Level 2 processing.

The determination of the PDU set and the classification of the PDU set importance may be further filtered by a second processing stage, the second processing stage assisted by metadata provided by the application for each of the plurality of PDUs within the PDU set to determine one or more PDU sets within the PDU set and classify the importance of each of the one or more PDU sets.

Metadata may be provided by the application via RTP PDU extension headers.

The QoS rules configuration may define a set of importance classes used for classification of the importance level of each PDU set.

The determination of a PDU set may comprise determining a PDU set boundary, wherein a PDU set boundary is determined by means of at least one of: RTP/SRTP packet header inspection, and RTP/SRTP packet extension header inspection.

The determination of the PDU set boundary may use at least one of: RTP/SRTP packet header, M-bit marker field, sequence number field, payload type field, timestamp field, and synchronization source (SSRC) field.

The classification of the importance level for each PDU set may comprise using at least one of: the QoS rules configuration, the NR application configuration of a video codec encoding profile, the determined PDU set size, and an RTP/SRTP extension header information.

The video codec may comprise H.264, H.265, H.266, AV1, etc.

PDU set size may be measured in bytes/octets, bits or equivalent measures.

The classification of the importance level for each PDU set may further comprise utilizing information containing at least one of: importance classes determined by the QoS rules; media bandwidth requirements; video codec encoding constant bit rate configuration; video codec encoding capped variable bit rate configuration; video codec encoding expected bit rate configuration; video codec encoding constant rate factor configuration; video codec encoding maximum frame size configuration; and video codec encoding expected frames per second.

The classification of the importance level for each PDU set can be obtained by means of SDP signaling or AF signaling to the PCF.

The transmission of the plurality of PDU sets may encapsulate for each of the PDU sets within a GPRS Tunnelling Protocol for User Plane (GTP-U) header field at least one of the information of: one or more boundaries of the PDU set, an importance indication of the PDU set, and a size indication of the PDU set.

PDU set size may be measured in bytes/octets, bits or equivalent measures.

The study of NR Media (XRM) at the CN level in Release 18 of the 3GPP technical standards introduced the concept of a PDU set to handle QoS requirements of XRM applications and streams with a better granularity beyond QoS flow possibilities. As such, according to 3GPP Technical Report TR 23.700-60 (v0.0.3), a PDU set is composed of one or more PDUs carrying the payload of one unit of information generated at the application level (e.g. a frame or video slice for NRM Services). In some implementations all PDUs in a PDU set are needed by the application layer to use the corresponding unit of information. In other implementations, the application layer can still recover parts or all of the information unit, when some PDUs are missing.

In addition, the PDU set is associated with QoS requirements in terms of delay budget and error rate, which may be defined as PDU Set Delay Budget (PSDB), and/or as a PDU Set Error Rate (PSER). The PDU Set Delay Budget (PSDB) defines an upper bound for the time that a PDU set may be delayed between the UE and the N6 termination point at the UPF. PSDB applies to the DL PDU set received by the UPF over the N6 interface, and to the UL PDU set sent by the UE, and respectively. The PDU Set Error Rate (PSER) defines an upper bound for the rate of PDU sets (e.g. set of IP packets constituting a PDU set) that have been processed by the sender of a link layer protocol (e.g. RLC in RAN of a 3GPP access) but where all of the PDUs in the PDU set are not successfully delivered by the corresponding receiver to the upper layer (e.g. PDCP in RAN of a 3GPP access). The PSER may be used to determine an upper bound for a rate of non-congestion-related packet losses.

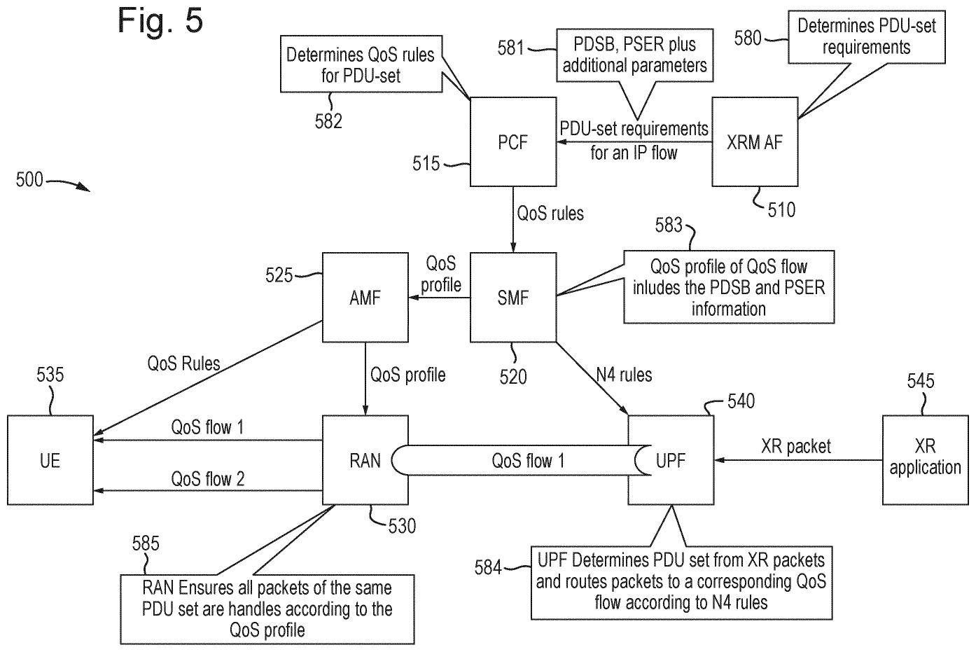

FIG. 5 illustrates an overview of a core network (CN) XRM architecture handling of PDU sets. FIG. 5 shows a system 500 comprising an Extended Reality Media Application Function (XRM AF) 510, a Policy and Control Function (PCF) 515, a Session Management Function (SMF) 520, an Access and Mobility Function (AMF) 525, a Radio Access Network (RAN 530, a User Equipment (UE) 535, a User Plane Function (UPF) 540, and an Extended Reality Application 545. The UE 535 may comprise a remote unit 102, a user equipment apparatus 200, or a UE 1035 as described herein. The UPF 540 may comprise a base unit 104, a network node 300, or a UPF 1040 as described herein. The operation of system 500 will now be described in the example of downlink traffic, a similar process may operate for uplink traffic.

At 580, the XRM AF 510 determines PDU set requirements.

At 581, the XRM Application Function 510 provides QoS requirements for packets of a PDU set to the PCF 515 and information to identify the application (i.e. 5-tuple or application id). The QoS requirements may comprise PSDB and PSER. The ARM AF 510 may also include an importance parameter for a PDU set and information for the core network to identify packets belonging to a PDU set.

At 582, the PCF 515 derives QoS rules for the NR application and specific QoS requirements for the PDU set. The QoS rules may use a 5G QoS identifier (5QI) for NR media traffic. The PCF 515 sends the QoS rules to the SMF 520. The PCF 515 may include in the communication to the SMF 520 Policy and Charging Control (PCC) rules per importance of a PDU set. The PCC rules may be derived according to information received from the XRM AF 510 or based on an operator configuration.

At 583, the SMF 520 establishes a QoS flow according to the QoS rules by the PCF 515 and configures the UPF to route packets of the NR application to a QoS flow, and, in addition, to enable PDU set handling. The SMF 520 also provides the QoS profile containing PDU set QoS requirements to the RAN 530 via the AMF 525. The AMF 525 may provide the QoS profile containing PDU set QoS requirements to the RAN 530 in an N2 Session Management (SM) container. Further, the AMF 525 may provide the QoS rules to the UE 535 in an N1 SM container.

At 584, the UPF 540 inspects the packets and determines packets belonging to a PDU set. The packet inspection may comprise inspecting the RTP packets. When the UPF 540 detects packets of a PDU set the UPF 540 marks the packets belonging to a PDU set within a GTP-U header. The GTP-U header information includes a PDU set sequence number and the size of the PDU set. The UPF 540 may also determine the importance of the PDU set either based on UPF 540 implementation means, information provided by the XRM AF 510 or information provided as metadata from an ARM application server. Based on the importance of the PDU set the UPF 540 may route the traffic to a corresponding QoS flow 1 (according to the rules received from the SMF 520) or include the importance of the PDU set within a GTP-U header. QoS flow 1 may comprise GTP-U headers, and these may include PDU set information.

At 585, the RAN 530 identifies packets belonging to a PDU set (based on the GTP-U marking) and handles the packets of the PDU set according to the QoS requirements of the PDU set provided by the SMF 520. In one implementation the RAN 530 node may use a different radio bearer with higher QoS requirement (according to the PDU set PSDB/PSER) to guarantee delivery of the packets of the PDU set, while using a different radio bearer according to the 5QI of the QoS flow for the non-PDU set packets. RAN 530 may receive QFIs, QoS profile of QoS flow from SMF 520 (via AMF 525) during PDU session establishment/modification which includes PDSB and PSER. RAN 530 inspects GTP-U headers and ensures all packets of the same PDU set are handled according to the QoS profile. This may include packets of PDU set in a radio bearer carrying QoS flow 1. This may also include sending packets not belonging to the PDU set in a different radio bearer carrying QoS flow 2.

The above example relates to downlink (DL) traffic. Reciprocal processing is applicable to uplink (UL) traffic wherein the role of UPF 540 packet inspection is taken by the UE 535 which is expected to inspect uplink packets, determine packets belonging to a PDU set, and signal accordingly the PDU set to the RAN 530 for scheduling and resource allocation corresponding to an associated DRB capable of fulfilling the PDU set QoS requirements (i.e., PSDB and PSER). The low-level signaling mechanism associated with the UL UE-to-RAN information passing are up to the specification and implementations of RAN signaling procedures.

Herein, extended Reality (NR) is used as an umbrella term for different types of realities, of which Virtual Reality, Augmented Reality, and Mixed Reality are examples.

Virtual Reality (VR) is a rendered version of a delivered visual and audio scene. The rendering is in this case designed to mimic the visual and audio sensory stimuli of the real world as naturally as possible to an observer or user as they move within the limits defined by the application. Virtual reality usually, but not necessarily, requires a user to wear a head mounted display (HMD), to completely replace the user's field of view with a simulated visual component, and to wear headphones, to provide the user with the accompanying audio. Some form of head and motion tracking of the user in VR is usually also necessary to allow the simulated visual and audio components to be updated to ensure that, from the user's perspective, items and sound sources remain consistent with the user's movements. In some implementations additional means to interact with the virtual reality simulation may be provided but are not strictly necessary.

Augmented Reality (AR) is when a user is provided with additional information or artificially generated items, or content overlaid upon their current environment. Such additional information or content will usually be visual and/or audible and their observation of their current environment may be direct, with no intermediate sensing, processing, and rendering, or indirect, where their perception of their environment is relayed via sensors and may be enhanced or processed.

Mixed Reality (MR) is an advanced form of AR where some virtual elements are inserted into the physical scene with the intent to provide the illusion that these elements are part of the real scene.

XR refers to all real-and-virtual combined environments and human-machine interactions generated by computer technology and wearables. It includes representative forms such as AR, MR and VR and the areas interpolated among them. The levels of virtuality range from partially sensory inputs to fully immersive VR. In some circles, a key aspect of XR is considered to be the extension of human experiences especially relating to the senses of existence (represented by VR) and the acquisition of cognition (represented by AR).

In 3GPP Release 17, 3GPP SA4 Working Group analyzed the Media transport Protocol and NR traffic model in the Technical Report TR 26.926 (v1.1.0) titled “Traffic Models and Quality Evaluation Methods for Media and NR Services in 5G Systems”, and decided the QoS requirements in terms of delay budget, data rate and error rate necessary for a satisfactory experience at the application level. These led to 4 additional 5G QoS Identifiers (5QIs) for the 5GS XR QoS flows. These 5Qis are defined in 3GPP TS 23.501 (v17.5.0), Table 5.7.4-1, presented there as delay-critical GBR 5QIs valued 87-90. The latter are applicable to NR video streams and control metadata necessary to provide the immersive and interactive NR experiences.

The NR video traffic is mainly composed of multiple DL/UL video streams of high resolution (e.g., at least 1080p dual-eye buffer usually), frames-per-second (e.g., 60+ fps) and high bandwidth (e.g., usually at least 20-30 Mbps) which needs to be transmitted across a network with minimal delay (typically upper bounded by 15-20 ms) to maintain a reduced end-to-end application round-trip interaction delay. The latter requirements are of critical importance given the NR application dependency on cloud/edge processing (e.g., content downloading, viewport generation and configuration, viewport update, viewport rendering, media encoding/transcoding etc.).

To support such stringent delay-critical requirements specific to real-time communications (RTC) with high bandwidth (e.g., NR video streams) the envisioned higher-layer protocols for delivery of XR immersive multimedia applications is the Real-time Transport Protocol (RTP). In this context reference may be made to 3GPP Technical Report TR 26.928 (v17.0.0) titled “Extended Reality (NR) in 5G”. In some implementations, secured RTP variants such as vanilla Secure Real-time Transport Protocol (SRTP) or web browser based WebRTC stacks may be used to serve NR applications across mobile communications networks such as 5GS and alike.

RTP is a media codec agnostic network protocol with application-layer framing used to deliver multimedia (e.g., audio, video etc.) in real-time over IP networks, as defined in IETF standard RFC 3550 titled “RTP: A Transport Protocol for Real-Time Applications”. It is used in conjunction with a sister protocol for control, RTP Control Protocol (RTCP) to provide end-to-end features such as jitter compensation, packet loss and out-of-order delivery detection, synchronization and source streams multiplexing.

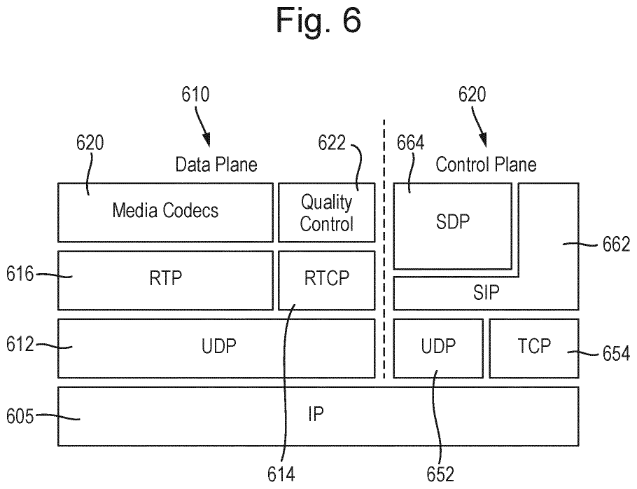

FIG. 6 provides an overview of the RTP and RTCP stack. An IP layer 605 carries signalling from the media session data plane 610 and from the media session control plane 650. The data plane 610 stack comprises functions for a User Datagram Protocol (UDP) 612, RTP 616, RTCP 614, Media codecs 620 and quality control 622. The control plane 650 stack comprises functions for UDP 652, Transmission Control Protocol (TCP) 654, Session Initiation Protocol (SIP) 662 and Session Description Protocol (SDP) 664.

SRTP is a secured version of RTP, and is defined by the IETF in RFC 3711 “The Secure Real-time Transport Protocol (SRTP)”. SRTP provides encryption (payload confidentiality), message authentication and integrity (header and payload signing), replay attack protection. Similarly, the SRTP sister protocol SRTCP provides the same functions to the RTCP counterpart. As such, in SRTP, the RTP header information is still accessible but non-modifiable, whereas the payload is encrypted. SRTP is used for this reason in the WebRTC stack which ensures secure RTC multimedia communications over web browser interfaces.

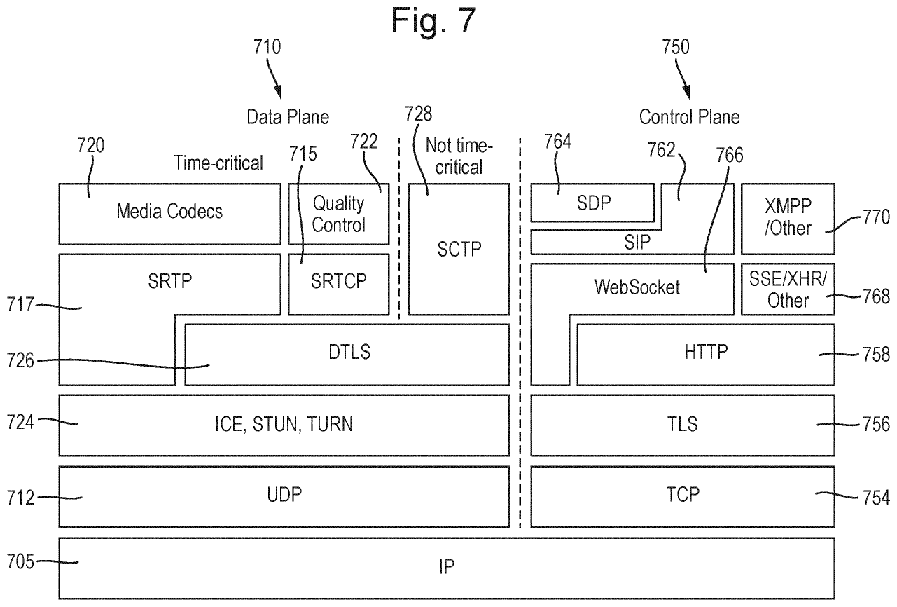

FIG. 7 illustrates an overview of the WebRTC stack. An IP layer 705 carries signalling from the data plane 710 and the control plane 750. The data plane 710 stack comprises functions for UDP 712, Interactive Connectivity Establishment (ICE) 724, Datagram Transport Layer Security (DTLS) 726, SRTP 717, SRTCP 715, media codes 720, Quality Control 722 and SCTP 728. ICE 724 may use the Session Traversal Utilities for NAT (STUN) protocol and Traversal Using Relays around NAT (TURN) to address real-time media content delivery across heterogeneous networks and NAT rules. SCTP 728 may be non time critical. SRTP 717, SRTCP 715, media codes 720, and Quality Control 722 may be time critical.

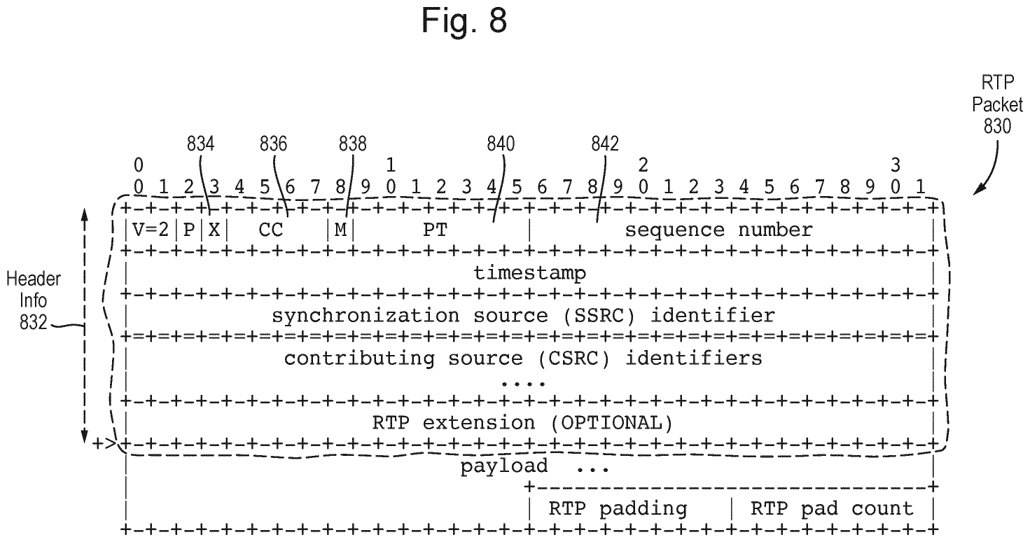

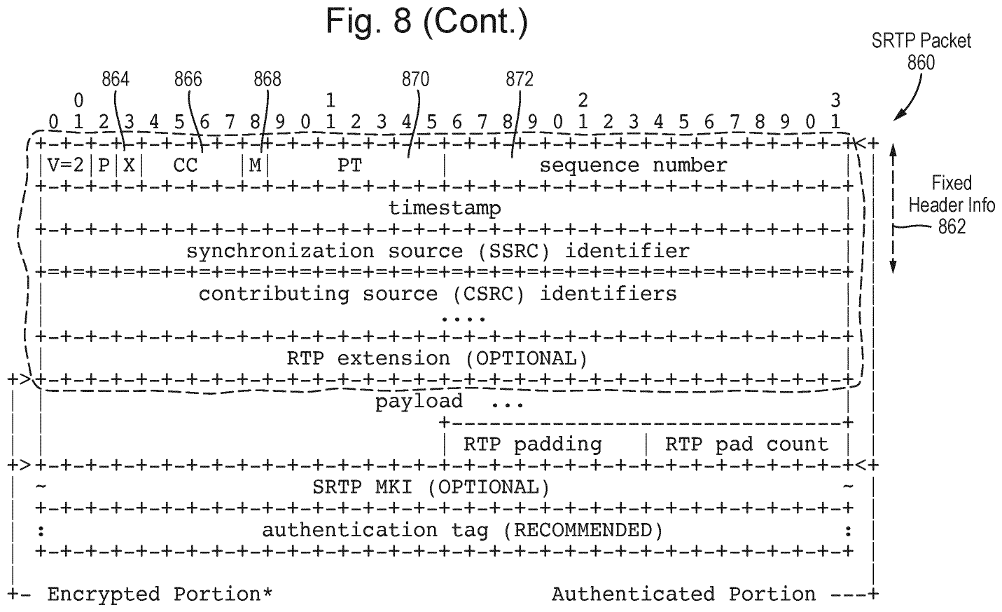

FIG. 8 illustrates packet format and header information for both an RTP packet 830 and an SRTP packet 860. The header information is available for inspection and processing and an overview is provided below including a brief description of certain fields of interest in the header portion of the RTP/SRTP packet formats

“X” 834, 864 is 1 bit indicating that the standard fixed RTP/SRTP header will be followed by an RTP header extension usually associated with a particular data/profile that will carry more information about the data (e.g., the frame marking RTP header extension for video data, as defined in RTP Frame Marking RTP Header Extension (November 2021)-draft-ietf-avtext-framemarking-13).

“CC” 836, 866 is 4 bits indicating number of contributing media sources (CSRC) that follow the header.

“M” 838, 868 is 1 bit intended to mark information frame boundaries in the packet stream, whose behavior is exactly specified by RTP profiles (e.g., H.264, H.265, H.266, AV1 etc.)

“PT” 840, 870 is 7 bits indicating the payload type, which in case of video profiles is dynamic and negotiated by means of SDP (e.g., 96 for H.264, 97 for H.265, 98 for AV1 etc.).

“Sequence number” 842, 872 is 16 bits indicating the sequence number which increments by one with each RTP data packet sent over a session.

“Timestamp” 844, 874 is 32 bits indicating timestamp in ticks of the payload type clock reflecting the sampling instant of the first octet of the RTP data packet (associated for video stream with a video frame), whereas the first timestamp of the first RTP packet is selected at random.

“Synchronization Source (SSRC) identifier” 846, 876 is a 32 bit field indicating a random identifier for the source of a stream of RTP packets forming a part of the same timing and sequence number space, such that a receiver may group packets based on synchronization source for playback.

Hereafter we refer to a video frame as a video coded representation of a still image presented in a sequence composing a video stream. On the other hand, a video frame may be composed of one or more video slices. A video slice is a coded video representation of a partition of a still image part of a video sequence. In some implementations video slices may be referred to rectangular partitions (e.g., tiles) of the still image (e.g., H.266, AV1), whereby in other implementations video slices may be raster scan partitions of the still image (e.g., H.264, H.265, H.266 etc.). Similarly, we refer to a video layer as a video coding element either as a temporal video layer meant to increase the frames per second resolution and temporal level of details of a video sequence or as a spatial video layer meant to increase the number of video coded pixels and spatial resolution of individual video frames of a video sequence. The abstract concepts of video frame, video slice and/or video layers are applicable to MPEG family of modern hybrid video codecs (i.e., H.264/H.265/H.266), as well as other open video codecs such as AV1 or VP9. The encapsulation format of video coded data to RTP/SRTP payloads is specified by Internet Standards for each individual video codec, e.g., H.264 by RFC 6184, H.265 by RFC 7798, AV1 by, for example, RTP Payload Format for AV1 (aomediacodec.github.io).

Note that for an NR application the media codecs used, and their configuration/configuration updates depend on the application implementation, and these are usually negotiated between a sender and a receiver upon session establishment/session update (e.g., RTP/SRTP). To this end, Session Description Protocol (SDP) signaling is used either as standalone signaling procedure or as part of the Session Initiation Protocol (SIP).

To determine PDU sets and manage for an NR QoS flow implies solving two problems: the determination of PDU set boundaries (PSB); and the classification of the PDU set importance (PSI) in accordance with some importance classes and/or associated priority levels given the NR application. Although, there are certain benefits to only determining set boundaries without classifying the determined sets.

These two problems are to be solved either at the UPF level for DL or at the UE level for UL whereby the processed results are used in DL as described in the prequel to setup, configure and map PDU sets to appropriate QoS rules by means of QoS flow. On the other hand, in UL the UE will use the processed results to map the PDU sets accordingly to appropriate DRBs which are subsequently remapped by the RAN over N3 to QoS flow by means of SDAP processing. The UPF shall then route the UL to the application server as per the PCF configured QoS rules and SMF setup QoS flow.

Current solutions discussed in the context of Release 18 NRM SI target PSB determination mainly by means of 2 strategies: Deep packet inspection; and RTP header information parsing. The first solution space (i.e., deep packet inspection) has the disadvantage that it is computational heavy with training and deployment requirements that make it infeasible for application in the UL direction for the UE processing. Solutions that refer to using RTP packet format leverage a combination of one or

more of the RTP timestamp, sequence number and M-bit marker to determine video frame boundaries. This information is complemented in some solutions by additional information extracted from application-specific and/or profile-specific RTP header extensions (e.g., draft-ietf-avtext-framemarking-13) or from parsing the RTP payload headers (e.g., of the video coded NAL units in H.26x codecs). This last collected information is then used to extract some classification/estimation of the importance of the detected PDU set (e.g. some solutions are listed in 3GPP TR 23.700-60 (v0.0.3) titled “Study on NR (Extended Reality) and media services”).

However, extracting such additional information from RTP payload is not always possible (e.g., in SRTP or WebRTC the payload is encrypted), whereas application-specific/profile-specific RTP extension headers need to be handled uniformly across various video codecs and profiles (e.g., draft-ietf-avtext-framemarking-13) and should be treated as a last resort approach according to RFC 3550.

As an aside it is noted that 3GPP TR 23.700-60 (v0.0.3) titled “Study on XR (Extended Reality) and media services” describes using RTP packet format to leverage a combination of one or more of the RTP timestamp, sequence number and M-bit marker to determine video frame boundaries. This information is complemented in some solutions by additional information extracted from application-specific and/or profile-specific RTP header extensions (e.g., draft-ietf-avtext-framemarking-13) or from parsing the RTP payload headers (e.g., of the video coded NAL units in H.26x codecs). This last collected information is then used to extract some classification/estimation of the importance of the detected PDU set.

In contrast, the solution presented herein uses a hierarchical filtering approach configurable based on operator and/or AF configuration for determining PSB and/or PSI. A zeroth filter stage (baseline) determines PSB based on RTP/SRTP fixed header. A first filter stage uses the AF codec config to classify importance of detected PDU sets given an NR application QoS requirements based on PDU sets sizes and video codec configuration (e.g., video codec constant bit rate (CBR) configuration, video codec variable capped bit rate (cVBR) configuration, and/or video media bandwidth requirements). A second filter stage is an application-aided filter that uses application metadata (e.g., RTP extension header) to refine the first two stages and break PDU sets from frame to temporal/spatial/slice PDU set mapping and reclassify the smaller PDU sets importance.

The proposed solution includes mapping NR application information units to PDU sets. According to some examples presented herein, this is performed by the principle of packet filtering, whereby the packet filtering comprises hierarchically processing the RTP packets encapsulating the XR application information. Conversely, the mapping of XR application data to PDU sets may be processed over RTP packets (or encapsulated RTP packets over a transport protocol, e.g., UDP) as:
received for DL transmission over the N6 interface whereby the processing is performed by a packet filtering instance within the UPF; and
received for UL transmission at the UE whereby the processing is performed by a packet filtering instance pre-SDAP layer processing.

The filtering is configured based on the PDU established session media codec (e.g., video) configurations of the application negotiated during the PDU session initialization/update by means of SDP offer/answers whereby the latter configurations further determined alongside other AF information signaling (e.g., 5 tuple describing service endpoint, bandwidth/PDSB/PSER requirements, application/protocol information etc.) the QoS rules derived by the PCF.

The configuration of the packet filter controls hierarchical processing. The hierarchical processing may comprise a baseline processing stage, a first processing stage and a second processing stage. The baseline processing stage may comprise a zeroth processing stage. The baseline processing stage may comprise Level 0 processing. The first processing stage may comprise Level 1 processing. The second processing stage may comprise Level 2 processing.

Level 0 processing comprises a determination of coarse PDU set boundaries. In any event, this may comprise an initial rough estimation of PDU set boundaries. The packet filter processes only the RTP fixed header information, e.g., at least the M-bit marker and the sequence number of the RTP packet, to determine a sequence of PDUs forming a PDU set. The output of Level 0 processing is a PDU set, whereby the PDU set is determined by its PSB. The outcome of Level 0 processing may result in an output of a PDU set mapped to a video frame/single video slice (e.g., as in for H.264, H.265, H.266, AV1 specifications).

Level 1 processing comprises a coarse determination of PDU set boundaries and an importance determination. Upon completion of Level 0 processing, the packet filter additionally processes the determined PDU set size and uses the PDU session codec configuration information as provided by the PCF to determine the importance of the PDU set, whereby the determined importance corresponds to some predefined PCF importance levels given an AF configuration and QoS requirements. The predefined importance levels may comprise HIGH and LOW, or alternatively HIGH, MEDIUM and LOW. Adding more predefined importance levels improves the granularity of the importance classification.

In some embodiments the outcome of Level 1 processing outputs a PDU set mapped to a video frame or video slice (similar to Level 0 processing) with an additional indication of an estimate of absolute importance of the video frame/video slice for the served XR application.

Level 2 processing comprises a fine PDU set boundaries and importance determination. Upon completion of Level 1 processing, the determined PDU set and importance, i.e., PSB and PSI, are further refined whereby additional application-/media codec-specific information is processed (e.g., RTP extension headers carrying information about the media coded units of information encapsulated by the RTP and/or SDP comprised media codec related information). The output of level 2 may be finer-grained PSB and associated PSI splitting PSB and PSI of Level 1 into one or more PDU sets given the application/media codec-specific information.

Where XR application support is enabled for Level 2 (e.g., by means of a standardized RTP extension header and/or by an operator configuration), additional processing maps a PDU set to one of a video frame, video slice or video layer. In such implementations, the processing parses the application/video codec metadata (e.g., standardized RTP extension header) to determine finer PDU sets boundaries for a finer level of QoS controlled by the CN. In some implementations the application may additionally indicate by RTP extension header fields the importance of the individually determined PDU sets.

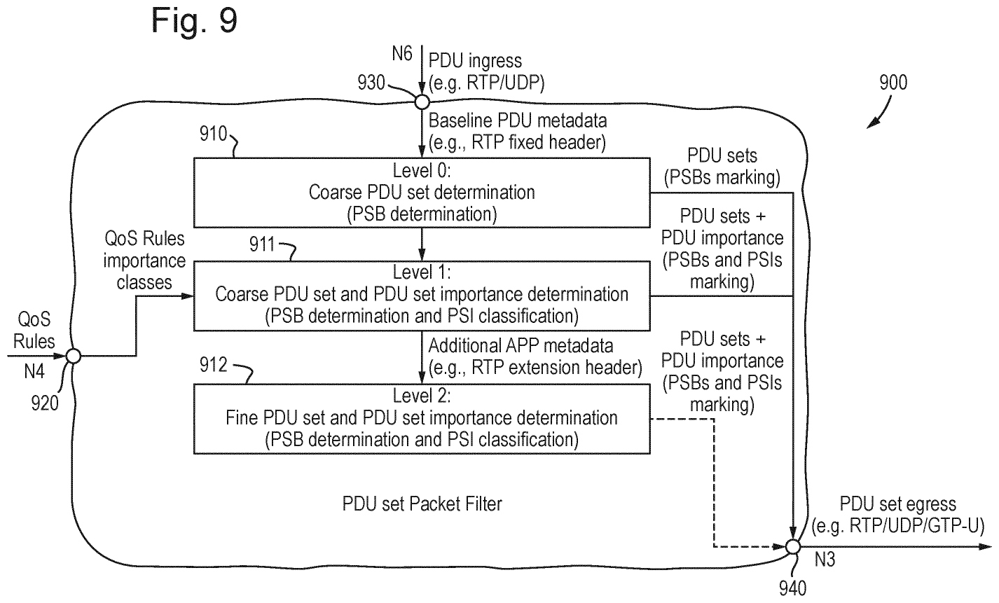

FIG. 9 illustrates a PDU set Packet Filter 900 comprising hierarchical processing in the form of Level 0, 910, Level 1, 911, and Level 2, 912. An input 920 receives QoS rules over an N4 interface. A PDU ingress port 930 receives PDUs via an N6 interface. The PDUs may be received at the filter 900 via RTP or UDP. The output of the filter is a PDU set egress port 940 which outputs PDU sets using interface N3 and via RTP over UDP tunneled via GTP-U protocol.

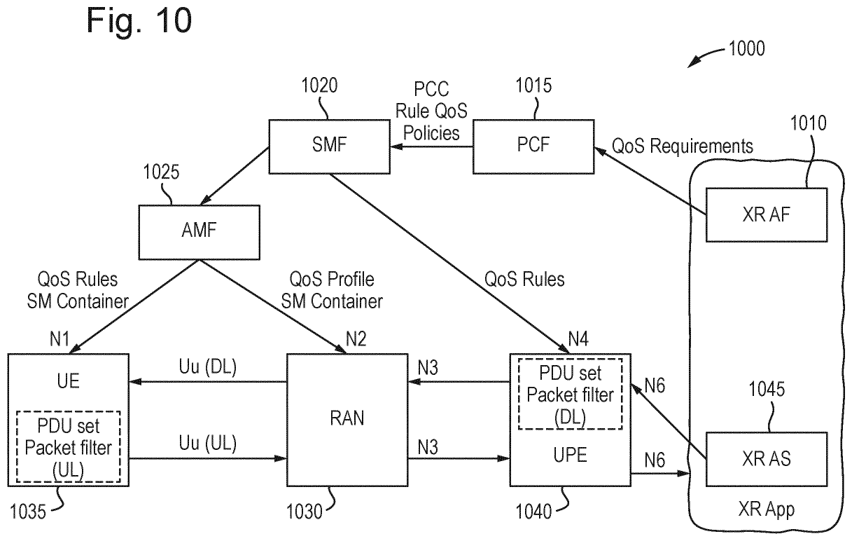

FIG. 10 illustrates the application of the packet filtering in the XRM service across a 5GS in both DL and UL. FIG. 10 shows a system 1000 comprising an Extended Reality Media Application Function (XR AF) 1010, a Policy and Control Function (PCF) 1015, a Session Management Function (SMF) 1020, an Access and Mobility Function (AMF) 1025, a Radio Access Network (RAN 1030, a User Equipment (UE) 1035, a User Plane Function (UPF) 1040, and an Extended Reality Application Service (XR AS) 1045. The UE 1035 may comprise a remote unit 102, a user equipment apparatus 200, or a UE 535 as described herein. The UPF 1040 may comprise a base unit 104, a network node 300, or a UPF 540 as described herein.

The operation of system 1000 will now be described in the example of downlink traffic, a similar process may operate for uplink traffic. The PCF 1015 decides on the PCC rules for a QoS flow and the processing level of PDU sets based on requirements provided by the NR AF or based on operator configuration. The PCC rules include information to enable PDU set detection for packets of a service data flow (identified by a 5-tuple) and corresponding processing level information. The PCC rules are sent to the SMF 1020 which in turn establishes a QoS flow and provides N4 rules to the UPF 1040 instructing the UPF 1040 to enable PDU set detection and marking of identified packets of a PDU set within GTP-U headers of the QoS flow over N3 reference point to the RAN 1030. The SMF 1020 also provides within QoS profile information of the PDU set requirements to the RAN 1030.

Filter Level 0 comprises a Coarse PDU set determination. Level 0 processing results in a baseline PDU set determination given processing of basic fixed header information available in RTP/SRTP payloads transporting XR media streams (e.g., video coded streams). As this header information is always available in the UDP payload at the UPF (in DL) or UE (in UL) its processing requires in some examples the parsing and evaluation of at least 12 octets of information according to the version 2 of the RTP protocol.

The M-bit marker may be used to determine the end of a unit frame of media information. In some examples, XR implementations serving video coded media (e.g., H.264/H.265/H.266) the M-bit marker in the RTP header determines the end of a video frame, and as such of a PDU set encapsulating a video frame. In some examples such a video frame may be an intra-coded video frame (i.e., an I-frame) which may additionally contain at the beginning various parameter sets (xPS) (e.g., video parameter set, picture parameter set, sequence parameter set) and/or supplemental enhancement information (SEI). In another example NR implementation serving video coded media (e.g., AV1/VP8/VP9) the M-bit marker in the RTP similarly marks the end of a video frame.

The sequence number of RTP packets and the M-bit marker may be processed and used to determine a sequence of RTP PDUs encapsulating one or more frames of media information of an application. The continuous sequence (i.e., consecutive sequence numbered RTP PDUs) of encapsulated RTP PDUs form as such a PDU set according to the PDU set definition. The determined PDU set based on this information is delimited by at least one of a start and end delimiter to signal its PSBs. Alternatively, additional information for processing of PDU sets by lower layers (e.g., PDU set sequence numbers, PSB, PDU set size) may be encapsulated in lower layers headers (e.g., GTP-U headers) for transport over the 5GS and CN tunnel to the RAN.

Additional RTP fixed header information, e.g., payload type, timestamp and synchronization source (SSRC), may be additionally used for better, more accurate PSB identification and PDU set detection associated with a media source and profile.

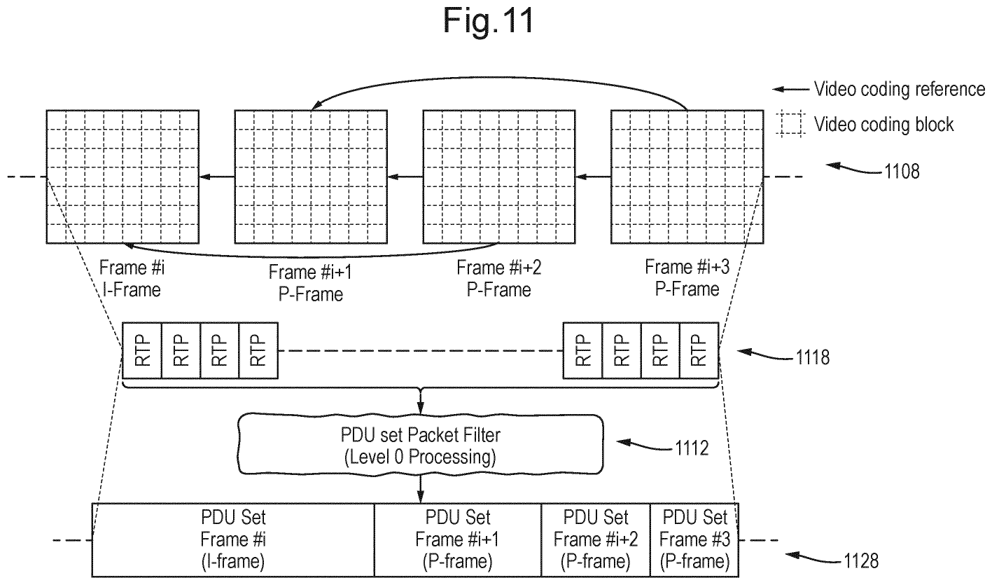

FIG. 11 is an illustration of applying of Level 0 processing PDU set packet filter on RTP stream carrying payload of video coded bitstream and mapping to PDU sets. A series of video frames 1108 are carried by a series of RTP packets 1118. A PDU set Packet Filter 1112 performs Level 0 Processing on the RTP packets 118. The output of the PDU set Packet Filter 1112 is a plurality of PDU sets 1128 wherein each PDU set corresponds to a respective video frame 1108.

Filter Level 1 comprises a Coarse PDU set and importance determination. Level 1 processing is applied on top of results from the Level 0 processing for the purpose of additionally determining the importance of a PDU set given a finite set of importance classes as defined by the PCF QoS rules upon the AF QoS requirements. The PCF may configure the set of importance classes (i.e. the number of levels, e.g., HIGH, MEDIUM, LOW) to better support the AF QoS requirements. The operator-controlled PCF may determine the set of importance classes upon request by the AF under a service level agreement to better serve high fidelity XR applications and/or advanced NR features.

For example, the AF may request the PCF to configure a PCC given the following QoS requirements for PDU set enabled communications:
PDU set size<70000 Bytes: PSDB=20 ms, PSER=2%
PDU set size≥70000 Bytes: PSDB=15 ms, PSER=1%.

As a result, the PCF may configure a PCC and QoS rules mapped to a QoS flow supporting the AF traffic minimum requirements, i.e., PSDB=15 ms and PSER=1%. In addition, the PCF QoS rules may categorize 2 or more levels of importance for the same QoS flow given the PDU set size, i.e., a HIGH importance for packets of PDU set size bigger or equal than 70000 bytes, and a DEFAULT importance for packets of PDU set size smaller than 70000 bytes traffic. The UPF uses then the PDU set size thresholding (as indicated by the AF) within the determined QoS rules and marks accordingly the importance of PDU sets.

Further, support of sub QoS flows of a QoS flow may be enabled. Each sub QoS flow of a QoS flow supports different QoS requirements. For example, sub QoS flow #1 may carry traffic consisting of PDU sets with PSDB 20 ms and PSER 2%, i.e., PDU set sizes less than 70000 bytes, whereas sub QoS flow #2 may carry traffic corresponding to PDU sets of sizes larger or equal to 70000 bytes, PSDB 15 ms and PSER 1%. The UPF uses then the PDU set size thresholding (as indicated by the AF to the PCF) within the determined QoS rules, determines accordingly the importance of PDU sets and maps the PDU sets to the corresponding sub QoS flows within the QoS flow of the application.

Level 1 processing uses PSBs and PDU sets determined by Level 0 to inspect the PDU set size (e.g., in number of bytes/octets, bits or any equivalent measure). Level 1 processing may then use the determined PDU set size and applies the QoS rules thresholding to determine and classify the importance of a PDU set given the importance classes configured by the PCF QoS rules. In one example, a PDU set with a large size exceeding a threshold, e.g., 70000 bytes, would be classified as a PDU set with HIGH importance, whereas a PDU set with a size not exceeding the threshold, e.g., 70000 bytes, would be classified as PDU set with LOW (or DEFAULT) importance.

The UPF (in DL)/UE (in UL) filters additionally (i.e., relative to Level 1 filtering procedures) media session negotiation/update protocols PDUs (e.g., SDP/SIP or SDP offers/answers) belonging to the same application ID/application server as the determined QoS rules. The UPF (in DL)/UE (in UL) is thus able to intercept and interpret media stream metadata, such as video codec configuration information, e.g., as a combination of video codec type (e.g., H.264, H.265, AV1 etc.), video codec format (e.g., YUV 444, YUV 420 etc.), video frames per second (e.g., 60, 90, 120 fps), maximum video frame size, average rate/bandwidth requirements, video codec constant bit rate configuration, video codec capped variable bit rate configuration, video codec constant rate factor configuration, to extract relevant thresholding features for importance characterization for a media stream. The UPF/UE may then utilize the extracted thresholding features to determine a set of importance thresholds and associated importance classes. The determined thresholding and classes are used then by the UPF (in DL)/UE (in UL) to classify PDU sets importance levels.

In some embodiments the Level 1 processing determines based on the number of N importance classes configured by the PCF QoS rules a number of N−1 PDU set size thresholds. The Level 1 processing applies then the thresholds to classify Level 0 determined PDU sets importance according to the importance classes as configured by the PCF QoS rules. In other embodiments, the N−1 PDU set size thresholds may be signaled directly to the packet filter by the PCF together with the packet filter configuration given the derived QoS rules.

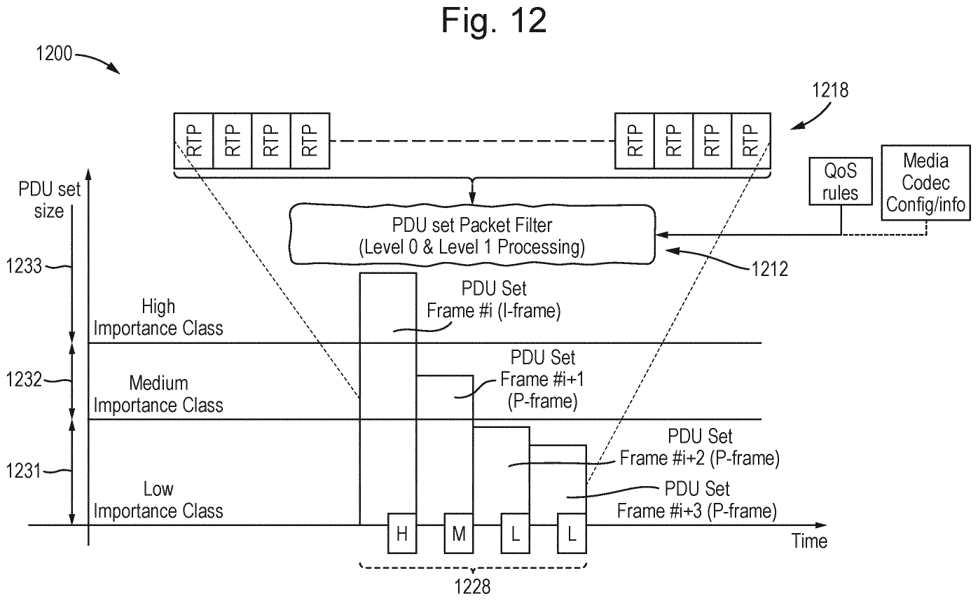

FIG. 12 illustrates the application of a Level 0 and a Level 1 filter process to a PDU stream. A series of RTP packets 1218 are fed into a PDU set Packet Filter 1212 that performs Level 0 Processing and Level 1 processing as described herein. The output of the PDU set Packet Filter 1212 is a plurality of PDU sets 1228 classified by importance. Three importance classes are defined, measured by PDU set size. A first class 1231 is a low importance class, a second class 1232 is a medium importance class, and a third class 1233 is a high importance class. By applying Level 0 processing followed by applying Level 1 processing of the PDU set filter 1212 on RTP stream 1218 carrying payload of video coded bitstream the PDU set packet filter 1212 will mark both PSB and PSI to determine both PDU sets and their importance given QoS rules importance classes.

The UPF may include information of the size of a PDU set within GTP-U header over N3 reference point. The RAN may implicitly determine the size of the PDU set by receiving (via GTP-U header info) that start/end of a PDU set. Once the RAN determines the size of the PDU set the RAN acts according to the QoS requirements corresponding to the size of the PDU set received within QoS profile information from the SMF.

Level 2 processing comprises a fine determination of PDU set and importance. Upon processing Level 0 and Level 1 packet filtering the determined PDU sets will enclose information describing complete video frames only. This is a consequence of the fact that the M-bit marker determines the end of application information frames applicable to video coded frames (i.e., a video coded representation of a still image presented in a sequence composing a video stream) in the video profiles of modern hybrid video codecs (e.g., H.264, H.265, H.266, VP8, VP9, AV1). To some NR applications and video coded configurations the latter outcome is insufficient. This is the case for XR applications that apply slicing in their encodings (i.e., whereby a video frame is coded as more than 2 video slices or, equivalently, tiles). A similar argument applies to applications using scalable video encodings using temporal or spatial enhancement video coded layers for support of progressive increase of video quality during transmission.

Such applications have the benefit of offering increased protection against packet losses as the video frame is segmented into multiple video coded slices which form finer-grained information and protect against bursty packet losses to a higher degree than traditional singular (non-sliced) video frame representation. Similarly, the argument applies to layered video encodings whereby enhancement layers are used to progressively increase the video quality of a base layer. To take advantage of such advanced encoding configurations, the RAN and CN need to be aware of the PDU sets at this level (i.e., video slices, layers, and their inter-dependencies), and as such a finer PDU set and importance determination needs to be performed than that of Level 0 and Level 1.

However, this is not possible in a consistent manner without the help of the NR application as this information would only be available at the level of video coded NAL units or, equivalently, in RTP payloads. Since in some embodiments this information may be further encrypted (e.g., for SRTP or WebRTC), applying for instance NAL unit parsers and specific filters is limited in such embodiments. As such, the NR application needs to provide media metadata information (finer grained PSBs markings and importance indicators) to benefit of its advanced encodings over a 5G and beyond system.

The application may signal via the AF to the PCF that it will provide such information as RTP extension headers together with the RTP extension header format used (e.g., RTP Frame Marking RTP Header Extension (November 2021)-draft-ietf-avtext-framemarking-13) as part of its QoS requirements. The PCF derives then QoS rules and importance classes and indicates to the UPF (in DL)/UE (in UL) the configuration which is used at UPF (in DL)/UE (in UL) for the packet filtering according to the RTP extension header format that enables Level 2 processing. In some embodiments Level 0 and Level 1 processing are performed as baseline and complemented once completed by Level 2, whereas in other embodiments Level 0 and Level 1 are skipped and replaced by Level 2 processing.

Level 2 processing may operate so as to parse an RTP extension header format (e.g., RTP Frame Marking RTP Header Extension (November 2021)-draft-ietf-avtext-framemarking-13) and determine additional information such as at least one of slice/temporal layer/spatial layer boundaries, frame/slice/temporal layer/spatial layer references and dependencies, and slice importance levels. These are then processed and used to determine video coded slice-level and/or layer-level PDU sets and importance as indicated by the RTP extension header of the NR application. The importance level of the PDU sets may be indicated by the RTP extension header explicitly by the application and the UPF/UE packet filtering Level 2 processing maps the latter to the PCF determined importance classes. In other arrangements, Level 2 processing may determine and classify the PSI of a PDU set given the RTP extension header format and thereby enclosed information.

Level 2 processing may be enabled upon operator configuration given AF request under an SLA for support of high fidelity XR applications. Alternatively, Level 2 processing is enabled only if the application RTP extension header is supported by the packet filtering implementation of a network operator.

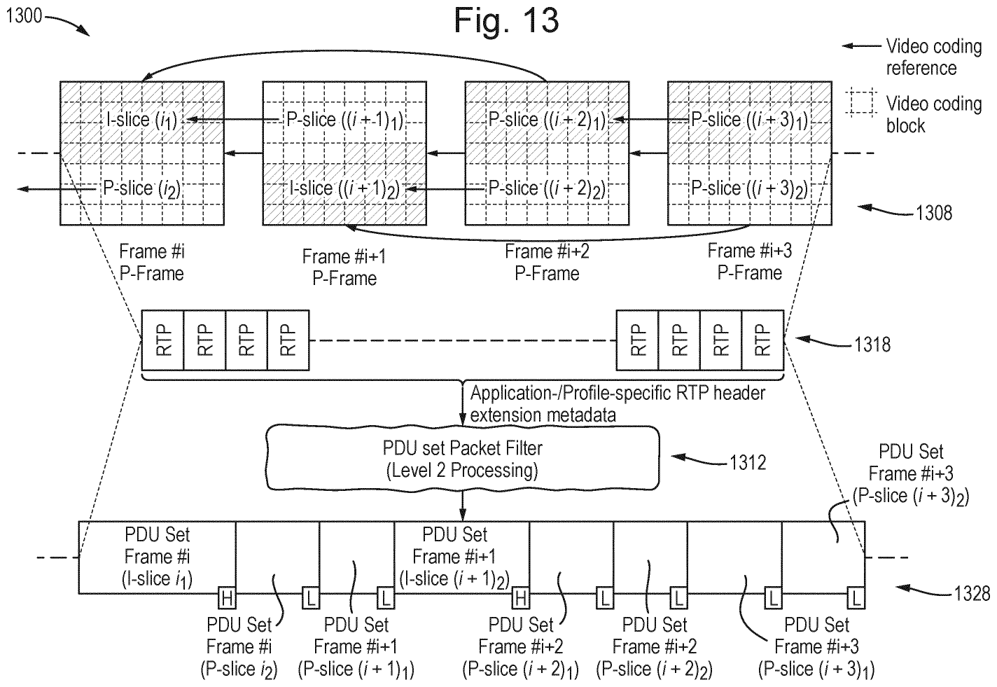

FIG. 13 is an illustration of applying up to Level 2 processing of the PDU set packet filter on RTP stream carrying payload of video coded bitstream. A series of video frames 1308 are carried by a series of RTP packets 1318. The RTP packets 1318 are fed into a PDU set Packet Filter 1312 that performs Level 2 Processing as described herein. The output of the PDU set Packet Filter 1312 is a plurality of PDU sets 1328 classified by importance. Three importance classes are defined as explained with reference to FIG. 12. Application-/profile-specific RTP header extension metadata is used by the PDU set packet filter 1312 to mark both PSB and PSI and thus to determine both PDU sets and their importance given QoS rules importance classes (e.g., High and Low) with a fine granularity up to, in this case, slice-level.

There is described herein methods, systems and apparatuses for mapping RTP video coded PDUs to PDU sets in the context of NR media and applications. PSB and PSI for PDU sets are determined based on RTP/SRTP packet filtering by the following: use of a scalable framework (applicable both for UPF and UE) for hierarchical filtering to determine PSB and PSI from coarse to fine-grained levels of information based on operator and AF configuration; and use of PDU set size to classify PDU set importance given PCF configured QoS rules and determined importance classes.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are relevant in the field: 3GPP, 3rd generation partnership project; 5G, fifth generation; 5GS, 5G System; 5QI, 5G QoS Identifier; AF, application function; AMF, access and mobility function; AR, augmented reality; DL, downlink; GTP-U, GPRS Tunnelling Protocol for User Plane; NAL, network abstraction layer; PCF, policy control function; PDU, packet data unit; PPS, picture parameter set; QoE, quality of experience; QoS, quality of service; RAN, radio access network; RTCP, real-time control protocol; RTP, real-time protocol; SDAP, service data adaptation protocol; SMF, session management function; SRTCP, secure real-time control protocol; SRTP, secure real-time protocol; UE, user equipment; UL, uplink; UPF, user plane function; VCL, video coding layer; VMAF, video multi-method assessment function; VPS, video parameter set; VR, virtual reality; XR, extended reality, XR AS, XR application server, and XRM, XR media.

What is claimed is:

1-22. (canceled)

23. A network node for wireless communication, comprising:
at least one memory; and
at least one processor coupled with the at least one memory and operable to cause the network node to:
receive a quality of service (QoS) rules configuration of QoS parameters of an application;
apply the received QoS rules configuration to a packet filter;
process packet data units (PDUs) of the application with the packet filter;
determine one or more PDU sets of the PDUs, wherein each PDU set groups a sequence of one or more PDUs comprising a unit of information of the application; and
transmit the one or more PDU sets, wherein at least a portion of the QoS rule configuration is applied to each PDU of the one or more PDU sets.

24. The network node of claim 23, wherein the at least one processor is operable to cause the network node to classify an importance of each PDU of the one or more PDU sets using metadata provided by the application for each PDU of the one or more PDU sets.

25. The network node of claim 23, wherein the one or more PDU sets comprise at least one of:
a video coded frame;
a video coded frame partition as a video coded slice;
a video coded temporal layer; or
a video coded spatial layer.

26. The network node of claim 23, wherein the one or more PDU sets are determined based at least in part on a PDU set boundary, and wherein the PDU set boundary is determined based at least in part on at least one of:
real-time transport protocol (RTP) packet header inspection;
secure RTP (SRTP) packet header inspection;
TRP packet extension header inspection; or
SRTP packet extension header inspection.

27. The network node of claim 26, wherein the PDU set boundary is further determined based at least in part on at least one of:
an RTP packet header;
an SRTP packet header;
a marker (M)-bit field;
a sequence number field;
a payload type field;
a timestamp field; or
a synchronization source (SSRC) field.

28. The network node of claim 23, wherein a general packet radio service (GPRS) tunneling protocol for user plane (GTP-U) header associated with the transmitted one or more PDU sets comprises one or more of:
one or more boundaries of the one or more PDU sets;
an importance indication of the one or more PDU sets; or
a size indication of the one or more PDU sets.

29. A method performed by a network node, the method comprising:
receiving a quality of service (QoS) rules configuration of QoS parameters of an application;
applying the received QoS rules configuration to a packet filter;
processing packet data units (PDUs) of the application with the packet filter;
determining one or more PDU sets of the PDUs, wherein each PDU set groups a sequence of one or more PDUs comprising a unit of information of the application; and
transmitting the one or more PDU sets, wherein at least a portion of the QoS rule configuration is applied to each PDU of the one or more PDU sets.

30. The method of claim 29, further comprising classifying an importance of each PDU of the one or more PDU sets using metadata provided by the application for each PDU of the one or more PDU sets.

31. The method of claim 29, wherein the one or more PDU sets comprise at least one of:
a video coded frame;
a video coded frame partition as a video coded slice;
a video coded temporal layer; or
a video coded spatial layer.

32. The method of claim 29, wherein the one or more PDU sets are determined based at least in part on a PDU set boundary, and wherein the PDU set boundary is determined based at least in part on at least one of:
real-time transport protocol (RTP) packet header inspection;
secure RTP (SRTP) packet header inspection;
TRP packet extension header inspection; or
SRTP packet extension header inspection.

33. The method of claim 32, wherein the PDU set boundary is further determined based at least in part on at least one of:
an RTP packet header;
an SRTP packet header;
a marker (M)-bit field;
a sequence number field;
a payload type field;
a timestamp field; or
a synchronization source (SSRC) field.

34. The method of claim 29, wherein a general packet radio service (GPRS) tunneling protocol for user plane (GTP-U) header associated with the transmitted one or more PDU sets comprises one or more of:
one or more boundaries of the one or more PDU sets;
an importance indication of the one or more PDU sets; or
a size indication of the one or more PDU sets.

35. A user equipment (UE) for wireless communication, comprising:
at least one memory; and
at least one processor coupled with the at least one memory and operable to cause the UE to:
receive a quality of service (QoS) rules configuration of QoS parameters of an application;
apply the QoS rules configuration to a packet filter;
process packet data units (PDUs) of the application with the packet filter;
determine one or more PDU sets of the PDUs, wherein each PDU set groups a sequence of one or more PDUs comprises a unit of information of the application; and
transmit the one or more PDU sets, wherein at least a portion of the QoS rule configuration is applied to each PDU of the one or more PDU sets.

36. The UE of claim 35, wherein the at least one processor is operable to cause the UE to classify an importance of each PDU of the one or more PDU sets using metadata provided by the application for each PDU of the one or more PDU sets.

37. The UE of claim 35, wherein the one or more PDU sets comprise at least one of:
a video coded frame;
a video coded frame partition as a video coded slice;
a video coded temporal layer; or
a video coded spatial layer.

38. The UE of claim 35, wherein the one or more PDU sets are determined based at least in part on a PDU set boundary, and wherein the PDU set boundary is determined based at least in part on at least one of:
real-time transport protocol (RTP) packet header inspection;
secure RTP (SRTP) packet header inspection;
TRP packet extension header inspection; or
SRTP packet extension header inspection.

39. The UE of claim 38, wherein the PDU set boundary is further determined based at least in part on at least one of:
an RTP packet header;
an SRTP packet header;
a marker (M)-bit field;
a sequence number field;
a payload type field;
a timestamp field; or
a synchronization source (SSRC) field.

40. The UE of claim 35, wherein a general packet radio service (GPRS) tunneling protocol for user plane (GTP-U) header associated with the transmitted one or more PDU sets comprises one or more of:
one or more boundaries of the one or more PDU sets;
an importance indication of the one or more PDU sets; or
a size indication of the one or more PDU sets.

41. A method performed by a user equipment (UE), the method comprising:
receiving a quality of service (QoS) rules configuration of QoS parameters of an application;
applying the received QoS rules configuration to a packet filter;
processing packet data units (PDUs) of the application with the packet filter;
determining one or more PDU sets of the PDUs, wherein each PDU set groups a sequence of one or more PDUs comprising a unit of information of the application; and
transmitting the one or more PDU sets, wherein at least a portion of the QoS rule configuration is applied to each PDU of the one or more PDU sets.

42. The method of claim 41, further comprising classifying an importance of each PDU of the one or more PDU sets using metadata provided by the application for each PDU of the one or more PDU sets.
